(19) United States
(12) Patent Application Publication
(10) Pub. No.: US 2026/0310282 A1
(43) Pub. Date: Oct. 8, 2026

(54) MULTI-MODAL LOCALIZATION OF STREAMING CONTENT PROVIDERS IN A VIRTUAL ENVIRONMENT

(71) Applicant: GOOGLE LLC, Mountain View, CA (US)

(72) Inventors: Ruofei Du, San Francisco, CA (US); David Kim, Zug (CH)

(21) Appl. No.: 19/481,795

(22) PCT Filed: May 31, 2023
(86) PCT No.: PCT/US2023/067708

§ 371 Date: Nov. 5, 2025

(51) Int. Cl. G06F 3/01; G06T 19/00

(52) U.S. Cl. CPC G06F 3/011; G06F 3/016; G06T 19/003

(57) ABSTRACT

Techniques of rendering an image of a mobile device in a virtual environment include a combination of depth images, ultra-wideband (UWB) signals, and inertial measurement unit (IMU) signals to track the position and orientation of a mobile device. The depth images may be generated using an RGB image acquired by the head-mounted display (HMD). The UWB and IMU signals may be generated by the HMD, although in some implementations UWB and HMD signals may also be generated by the mobile device. In some implementations, the depth images are sufficient to track the position and orientation of the mobile device. In some implementations, a combination of UWB and IMU signals are sufficient to track the position and orientation of the mobile device. In some implementations, a combination of the depth images and UWB and IMU signals are used to track the position and orientation of the mobile device.

### BACKGROUND

A virtual reality (VR) system that generates a virtual environment includes a VR computer and a controller. A human user experiences a virtual environment generated by the VR computer by interacting with various objects within the virtual environment. For example, the human user may use the controller to move an object through a translation and/or a rotation via a gesture. In some implementations, the controller includes a mobile device, e.g., a smartphone.

### SUMMARY

Implementations described herein are related to accurate rendering of streaming content in a virtual environment. For example, a user wearing a virtual reality (VR) head mounted display (HMD) (goggles) sees only objects within the virtual environment. In the real world (physical world), the user may receive an email or a text message on their mobile device. The user desires to interact with the streaming content without leaving the virtual environment. Such an interaction without leaving the virtual environment is made possible by rendering images of the streaming content and the mobile device within the virtual environment from a combination of ultra-wideband (UWB) signals, inertial measurement unit (IMU) signals, and depth images. In some implementations, the UWB and IMU signals are emitted from and received by the HMD. In some implementations, the images of the streaming content and mobile device are rendered based on a combination of UWB and IMU signals and depth images. The use of such a multi-modal combination of tracking methods allows for an improved calibration and even provides for a self-calibration of the tracking and results in a level of accuracy needed for certain applications.

In one general aspect, a method can include inputting depth image data, ultra-wideband (UWB) data, and inertial measurement unit (IMU) data into a machine learning engine at a refresh rate of a virtual environment, the depth image data including a depth image acquired at a first rate, the UWB data including samples of a UWB signal acquired at a second rate, the IMU data representing samples of a IMU signal acquired at a third rate, the first rate being different from at least one of the second rate or the third rate, the machine learning engine being configured to output a position value and an orientation value indicative of a position and an orientation of a mobile device within the virtual environment. The method can also include rendering a virtual object representing the mobile device in the virtual environment according to the position and orientation.

In another general aspect, a computer program product comprising a nontransitory storage medium, the computer program product including code that, when executed by at least one processor, causes the at least one processor to perform a method. The method can include acquiring, at a first rate, depth image data in a real-world environment. The method can also include acquiring, at a second rate, a sample of an ultra-wideband (UWB) signal. The method can further include acquiring, at a third rate, a sample of inertial measurement unit (IMU) signal, the first rate being different form at least one of the second rate or the third rate. The method can further include inputting the depth image data, the sample of the UWB signal, and the sample of the IMU signal into a machine learning engine at a refresh rate of a virtual environment, the machine learning engine being configured to output a position value and an orientation value indicative of a position and an orientation of a mobile device within the virtual environment. The method can further include rendering a virtual object representing the mobile device in the virtual environment according to the position and orientation.

In another general aspect, an apparatus comprises memory, and processing circuitry coupled to the memory. The processing circuitry can be configured to input depth image data, ultra-wideband (UWB) data, and inertial measurement unit (IMU) data into a machine learning engine at a refresh rate of a virtual environment, the depth image data including a depth image acquired at a first rate, the UWB data including samples of a UWB signal acquired at a second rate, the IMU data representing samples of a IMU signal acquired at a third rate, the first rate being different from at least one of the second rate or the third rate, the machine learning engine being configured to output a position value and an orientation value indicative of a position and an orientation of a mobile device within the virtual environment. The processing circuitry can also be configured to render a virtual object representing the mobile device in the virtual environment according to the position and orientation.

In one general aspect, a method can include inputting, into a machine learning engine at a refresh rate of a virtual environment, ultra-wideband (UWB) data, and inertial measurement unit (IMU) data, the UWB data including samples of a UWB signal acquired at a first rate, the IMU data representing samples of a IMU signal acquired at a second rate, the first rate being different from the second rate, the machine learning engine being configured to output a position value and an orientation value indicative of a position and an orientation of a mobile device within the virtual environment. The method can also include rendering a virtual object representing the mobile device in the virtual environment according to the position and orientation.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram illustrating an example head mounted wearable device worn by a user in a physical environment in the vicinity of a mobile device.

FIG. 1B is a diagram illustrating an image of the mobile device within a virtual environment.

FIG. 2 is a diagram illustrating an example electronic environment for performing the rendering of an image of the mobile device within the virtual environment.

FIG. 3A is a diagram illustrating an example data flow between UWB and IMU data, a depth image, and a previous 6DOF pose and a new 6DOF pose of the image of the mobile device in the virtual environment.

FIG. 3B is a diagram illustrating an example data flow between a depth image and a 6DOF pose of the image of the mobile device in the virtual environment.

FIG. 3C is a diagram illustrating an example data flow between UWB and IMU data and a 6DOF pose of the image of the mobile device in the virtual environment.

FIG. 3D is a diagram illustrating example rates of data acquisition of depth image data, IMU sample data, and UWB sample data compared with the rate of input into the ML engine (e.g., the refresh rate of the virtual environment).

FIG. 4 is a flow chart illustrating an example method for rendering images of streaming content and the mobile device per the improved techniques described herein.

### DETAILED DESCRIPTION

This disclosure relates to virtual reality headsets (e.g., goggles) and mobile device (e.g., smartphone, companion device) interactions within a virtual environment. A conventional virtual reality headset can track mobile devices accurately using an external marker such as a QR code on the mobile device. In one example, tracking of a 6DoF pose of mobile device in a virtual reality environment can allow a mobile device to be represented with a degree of accuracy in the virtual reality environment. In one example, because tracking enables the mobile device to be oriented correctly in the virtual environment, a user may read text messages, email, etc., on the representation of the mobile device in the virtual environment. In another example, as tracking enables a mobile device to be positioned correctly in a virtual environment, the mobile device could interact with virtual objects and be used, e.g., as a paddle in a game in the virtual environment.

A technical problem with the above-described conventional virtual reality headset is that accurate tracking of the pose of mobile devices in a virtual environment requires external markers such as QR codes on the phones. This would limit the phone from everyday use, e.g., text messages. Moreover, the accuracy of such external markers may not be sufficient for applications such as reading text messages or playing games.

In accordance with the implementations described herein, a technical solution to the above-described technical problem includes inputting a combination of depth image data, ultra-wideband (UWB) signal data, and inertial measurement unit (IMU) signal data into a machine learning engine to track the position and orientation of a mobile device. The depth image data may be generated using an RGB image acquired by the head-mounted display (HMD). The UWB and IMU signal data may be generated by the HMD, although in some implementations UWB and IMU signal data may also be generated by the mobile device. In some implementations, the depth image data, UWB signal data, and IMD signal data are received at the HMD at different rates. For example, the depth image data may be received at the HMD at a frame rate of 30 Hz (e.g., receiving depth image frames from an image capture device at the HMD at a rate of 30 Hz), the IMU signal data may be received at the HMD at a rate of 100 Hz (e.g., receiving samples of an IMU signal from an IMU unit at the HMD at the rate of 100 Hz), and the UWB signal data may be received at the HMD at a rate of 10 Hz (e.g., receiving samples of a UWB signal from a UWB unit at the HMD at a rate of 10 Hz). In some implementations, the depth image data, the UWB signal data, and the IMD signal data are received at the HMD at the same rates. Once received, the depth image data, the IMU signal data, and the UWB signal data are input into a machine learning engine that is configured to output mobile device 6DoF pose from the depth image data, the IMU signal data, and the UWB signal data.

In some implementations, the HMD includes processing circuitry that includes a machine learning engine configured to output a position value and an orientation value indicative of a position and orientation of the mobile device within a virtual environment based on input from a depth image. In some implementations, the machine learning engine includes an encoder-decoder. In some implementations, another machine learning engine is configured to convert an RGB image of the mobile device into a depth image for input into the machine learning engine. In some implementations, another machine learning engine is configured to interpolate time-of-flight data into a complete depth image for input into the machine learning engine. In some implementations, the depth image has a specified number of pixels, e.g., 512×512, 256×256, 128×128, and so on.

In some implementations, the HMD includes processing circuitry that includes a machine learning engine configured to output a position value and an orientation value indicative of a position and orientation of the mobile device within a virtual environment based on input from UWB and IMU data generated from UWB and IMU units in the HMD. In some implementations, additional data is generated from UWB and IMU signals in the mobile device. In some implementations, the machine learning engine includes an encoder-decoder. In some implementations, the machine learning engine takes as input multiple frames of UWB and IMU signals, e.g., 120 frames, 90 frames, 60 frames, 30 frames, 15 frames, and so on.

In some implementations, the HMD includes processing circuitry that includes a machine learning engine configured to output a position value and an orientation value indicative of a position and orientation of the mobile device within a virtual environment based on input from depth image data and UWB and IMU signal data. In some implementations, the machine learning engine includes an encoder-decoder. In some implementations, the depth image has a specified number of pixels, e.g., 512×512, 256×256, 128×128, and so on. In some implementations, the machine learning engine takes as input multiple frames of UWB and IMU signals, e.g., 120 frames, 90 frames, 60 frames, 30 frames, 15 frames, and so on.

In some implementations, the machine learning engine is trained using an external tracker on the mobile device as a source of ground truth data for position and orientation. In some examples, such an external tracker takes the form of a QR code which in real time represents the ground truth position and orientation of the mobile device.

A technical advantage of the above-described technical solution is that the use of such a multi-modal combination of tracking methods provides a self-calibration of the tracking and results in a level of accuracy needed for certain applications. For example, the technical solution enables a user to use a mobile device to read text messages, email, etc., while wearing and using the HMD. The technical solution also enables a user to move the mobile device as a paddle in a game in the virtual environment.

In some implementations, the technical solution enables the user to perform accurate finger tracking in the vicinity of the mobile device. For example, the technical solution enables the tracking to indicate that a fingertip of the user is within a specified distance (e.g., 2 cm) from the mobile device. In this example, in some implementations, when the fingertip is within the specified distance, the fingertip may draw on the mobile device screen using a brush which changes to a pen when the user is touching the screen.

In some implementations, the technical solution further includes acquiring streaming content from the mobile device; and displaying the streaming content from the mobile device at the position and orientation within the virtual environment. In such an implementation, the streaming content from the mobile device is acquired through a pairing of the mobile device and the HMD. The content is then displayed at a position and orientation as determined from the output of the machine learning engine.

Depth images are images that provide data on distance of objects from the HMD. In some implementations, depth images are generated using time-of-flight or LIDAR sensors. In such implementations, however, the resulting depth images may have locations where depth is not sampled. Such holes may be filled in using a neural network configured to interpolate the holes. In some implementations, depth images are generated from RBG images taken with, e.g., a world-facing camera.

Such RGB images may then be input into a neural network (e.g., a convolutional neural network) and converted to depth images. In some implementations, depth images are used to determine a distance between a mobile device and a head-mounted display (HMD).

Ultra-wideband (UWB) is a radio technology that can use a very low energy level for short-range, high-bandwidth communications over a large portion of the radio spectrum. For example, a UWB transmission may occupy a band between 6-9 GHz. UWB transmissions transmit information by generating radio energy at specific time intervals and occupying a large bandwidth, thus enabling pulse-position or time modulation. In some implementations, UWB is used to determine a distance between a mobile device and a head-mounted display (HMD), as well as an angle of the mobile device with respect to the HMD.

An inertial measurement unit (IMU) is an electronic device that measures a body's specific force, angular rate, and orientation, using a combination of accelerometers, gyroscopes, and magnetometers along each of three axes. The accelerometers are used to detect linear acceleration, the gyroscopes are used to detect a rotational rate, and the magnetometers are used as a heading reference. In some implementations, the IMU is used to estimate a 6DoF pose of the mobile device.

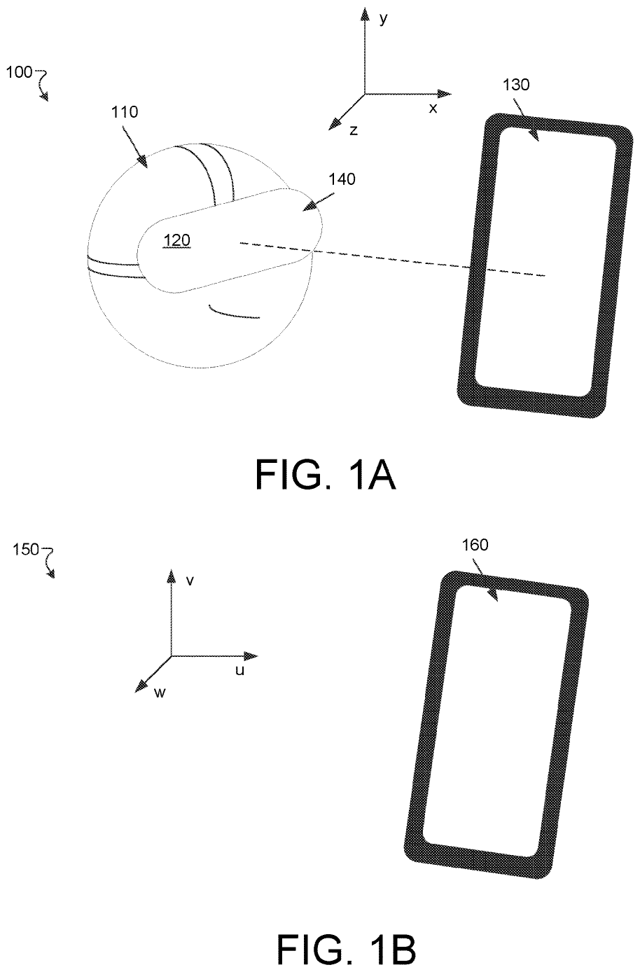

FIG. 1A is a diagram illustrating an example head mounted wearable device worn by a user 100 in a physical environment 100 in the vicinity of a mobile device 130. As shown in FIG. 1A, the head-mounted wearable device is a head-mounted display (HMD) 120 configured to produce a virtual environment for the user 110.

As also shown in FIG. 1A, the HMD 120 includes HMD circuitry 140 configured to track a distance and orientation of the mobile device 130 with respect to the HMD 120. In some implementations, the HMD circuitry 140 tracks a position and orientation of the HMD 120 in world coordinates, i.e., with respect to an external origin. In some implementations, the HMD circuitry 140 tracks a position and orientation of the mobile device 130 in world coordinates. In some implementations, the HMD circuitry 140 tracks a position and orientation of the mobile device with respect to the HMD 120.

To track the position and orientation of the mobile device 130 with a level of precision needed for a user to interact with the mobile device in a virtual environment, the processing circuitry 140 has multiple modes of data for input into a machine learning engine. For one mode, the HMD circuitry 140 includes a mechanism for generating depth images. In some implementations, the mechanism for generating depth images includes a world-facing camera for acquiring RGB images of the mobile device 130, as well as a machine learning engine for converting RBG images to depth images. In some implementations, the mechanism for generating depth images includes a time-of-flight or LIDAR sensing circuitry, as well as a machine learning engine for interpolation.

For other modes, the HMD circuitry 140 includes a mechanism for generating and receiving UWB signals. In some implementations, the HMD circuitry 140 includes an IMU as well as circuitry for receiving IMU signals.

FIG. 1B is a diagram illustrating an image 160 of the mobile device 130 within a virtual environment 150. Within the virtual environment 150, the image 160 of the mobile device 130 is positioned and oriented according to the position and orientation of the mobile device 130 in the physical environment 100, as determined by the HMD circuitry 140 of the HMD 120. In some implementations, the image 160 displays text and/or graphics in a text message or email as if the image 160 were the mobile device 130. That is, the text message or email is displayed in the image at a position and orientation as determined by the HMD circuitry 140, in the same way the position and orientation of the image 160 is determined.

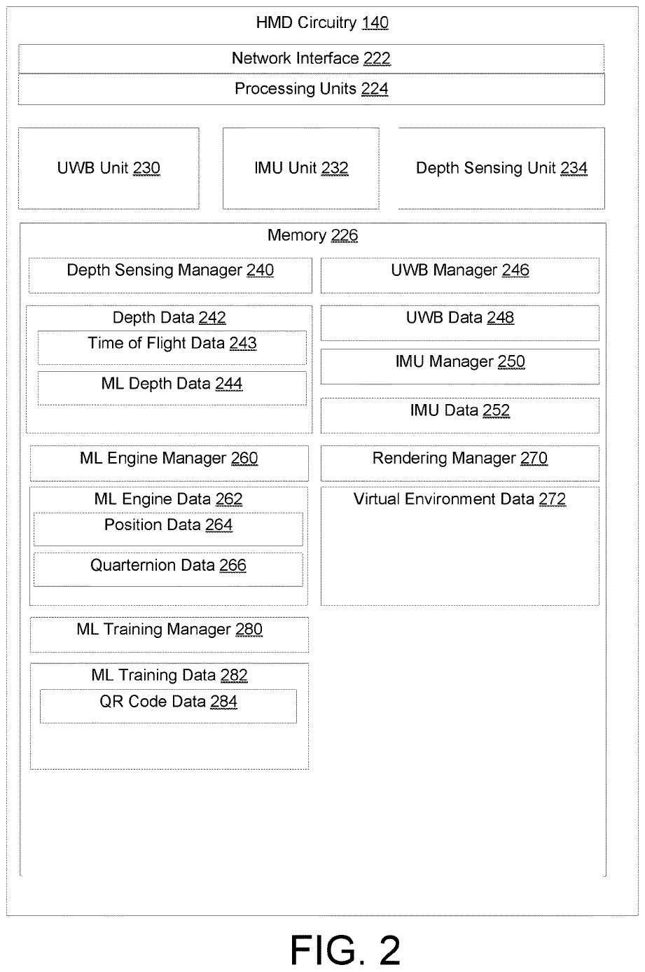

FIG. 2 is a diagram that illustrates an example of HMD circuitry 140. The HMD circuitry 140 includes a network interface 222, one or more processing units 224, and nontransitory memory 226. The network interface 222 includes, for example, Ethernet adaptors, Token Ring adaptors, and the like, for converting electronic and/or optical signals received from the network to electronic form for use by the HMD circuitry 140. The set of processing units 224 include one or more processing chips and/or assemblies. The memory 226 includes both volatile memory (e.g., RAM) and non-volatile memory, such as one or more ROMs, disk drives, solid state drives, and the like. The set of processing units 224 and the memory 226 together form processing circuitry, which is configured and arranged to carry out various methods and functions as described herein.

As shown in FIG. 2, the HMD circuitry 140 includes a UWB unit 230, an IMU unit 232, and a depth sensing unit 234. The UWB unit 230 is configured to generate UWB signals. The IMU unit 232 is configured to generate IMU signals.

The depth sensing unit 234 is configured to generate depth sensing signals. In some implementations, the depth sensing signals include LIDAR or time-of-flight signals. In some implementations, the depth sensing signals cause a world-facing camera to acquire an RGB image of a physical environment (e.g., that includes a mobile device).

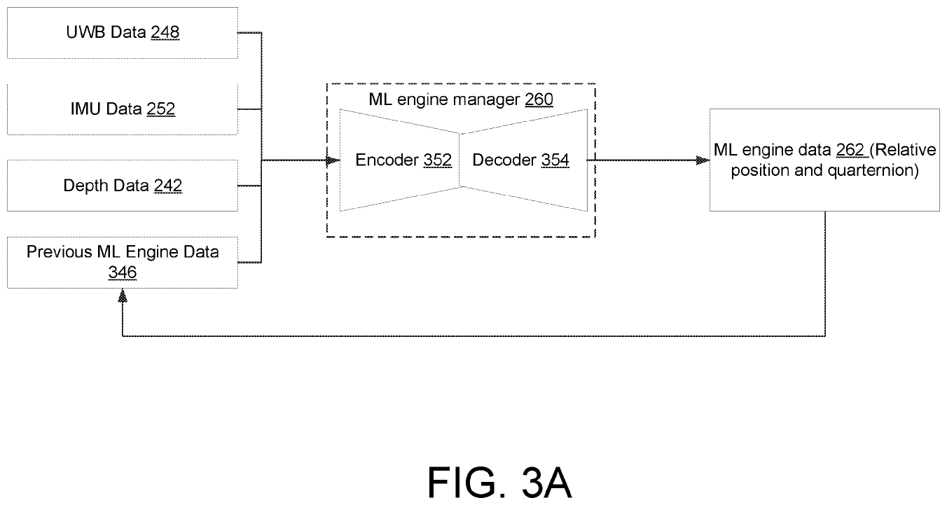

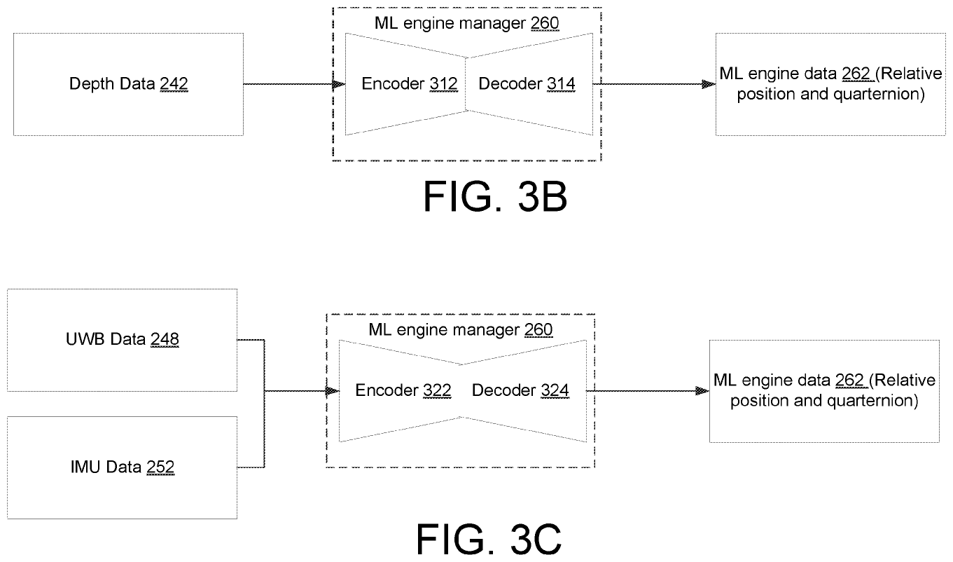

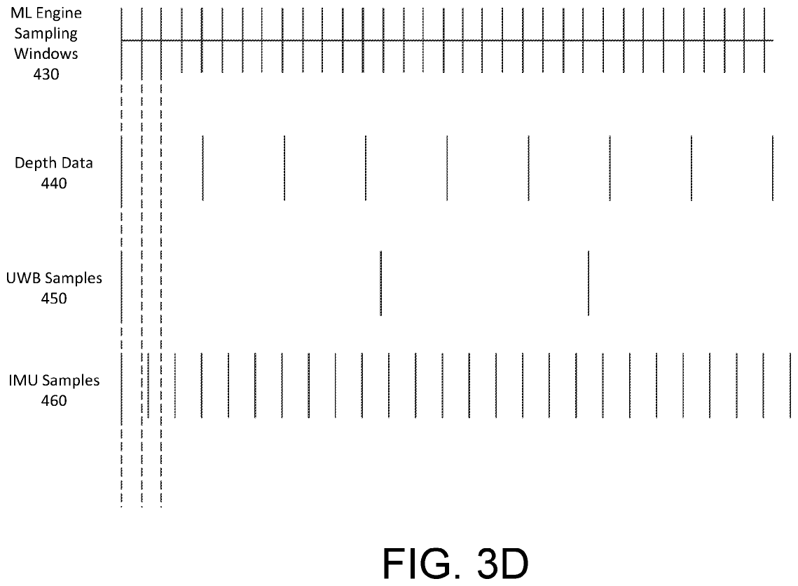

In some implementations, one or more of the components of the HMD circuitry 140 can be, or can include processors (e.g., processing units 224) configured to process instructions stored in the memory 226. Examples of such instructions as depicted in FIG. 3 include depth sensing manager 240, UWB manager 246, IMU manager 250, pose model manager 260, rendering manager 270, and machine learning (ML) training manager 280. Further, as illustrated in FIG. 3, the memory 226 is configured to store various data, which is described with respect to the respective managers that use such data.

The depth sensing manager 240 is configured to receive depth data 242 at a first rate, e.g., 30 Hz, 60 Hz, etc. In some implementations, the depth sensing manager 240 includes a machine learning engine for interpolating LIDAR or time-of-flight data. In some implementations, the depth sensing manager 240 includes a machine learning engine for converting an RGB image into a depth image.

The depth data 242 represents depth, or distance, in the physical environment with respect to the HMD. As shown in FIG. 2, the depth data 242 includes time of flight data 243 and machine learning (ML) depth data 244.

The time of flight data 243 represents the result of transmitting and receiving signals reflected off objects in the physical environment. Depth in this case is generated based on the time it takes for a reflected signal to be received after transmission. As the generated signals are not continuous in space, there may be spatial positions for which there is no time-of-flight, and hence, depth data. Accordingly, the depth sensing manager 240 includes a machine learning engine configured to interpolate the depth data and generate a depth image. In some implementations, the depth image has a specified number of pixels, e.g., 256×256.

The ML depth data 244 represents depth based on a single RBG image. That is, when the depth data 242 includes a single RBG image acquired with a world-facing camera, the depth sensing manager 240 includes a machine learning engine that takes the RGB image as input and returns a depth image. In some implementations, the depth image has a specified number of pixels, e.g., 256×256.

The UWB manager 246 is configured to receive UWB data 248 at a second rate, e.g., 10 Hz, 20 Hz, etc. In some implementations, the UWB data 248 is received from the mobile device. In some implementations, the UWB data 248 is received from the UWB unit 230. UWB data 248 represents, in some implementations, multiple samples of UWB signal amplitudes, e.g., 60 samples. It is noted that a sample of UWB data is the capturing of a UWB signal at an instant of time. Accordingly, 60 samples of UWB data at 10 Hz include 6 seconds worth of UWB signal data.

The IMU manager 250 is configured to receive IMU data 252 at a third rate, e.g., 100 Hz. IMU data 252 represents, in some implementations, multiple samples of IMU signal amplitudes, e.g., 60 samples. It is noted that a sample of IMU data is the capturing of a IMU signal at an instant of time. Accordingly, 60 samples of IMU data at 100 Hz include 0.6 seconds worth of IMU signal data.

The machine learning (ML) engine manager 260 is configured to generate pose model data 262 from depth data 242, a combination of UWB data 248 and IMU data 252, or a combination of depth data 242, UWB data 248, and IMU data 252. The various modes of data are input into the ML engine manager 260 at a refresh rate of the virtual environment, independent of the rates at which the various modes of data are received. For example, the latest depth image data 242, the most recently received 60 frames of UWB data 248, and the latest 60 frames of IMU data 252 are input into the ML engine manager 260.

The ML engine data 262 represents a 6DoF pose of the mobile device at an instant of time or over a series of time instants. As shown in FIG. 2, the ML engine data 262 includes position data 264 and quarternion data 266.

The position data 264 includes three numbers corresponding to three spatial coordinates representing a position of the mobile device in the virtual environment.

The quarternion data 266 includes four numbers corresponding to a four-element quarternion representing an orientation of the mobile device in the virtual environment.

Further details of the ML engine manager 260 are described with regard to FIGS. 3A-C. FIGS. 3A-C represent the data flow in and out of the ML engine manager 260 with regard to various input scenarios.

FIG. 3A is a diagram illustrating an example data flow between UWB data 248, IMU data 252, and depth data 242, and ML engine data 262. As shown in FIG. 3A, the UWB data 248, IMU data 252, and depth data 242 are input into the ML engine manager 260. As shown in FIG. 3A, the pose model manager includes an encoder 352 and a decoder 354. The encoder 352 is configured to take as input a combination of the UWB data 248, IMU data 252, and depth data 242 and output encoded data for input into the decoder 354. The decoder 354 is configured to take as input the encoded output of the encoder 352 and output the ML engine data 262, e.g., a 6DoF pose of the mobile device in the virtual environment.

The depth data 242, UWB data 248, and IMU data 252 may all be received at different rates. For example, depth data 242 may be received at 30 Hz, UWB data 248 may be received at 10 Hz, and IMU data 252 may be received at 100 Hz. Despite the fact that these modalities are received at different rate, the most recent data—e.g., the most recent depth image, the most recent 60 frames of UWB data, and the most recent 60 frames of IMU data-are input into the ML engine manager 260 at the refresh rate of the virtual environment, e.g., 60 Hz, 120 Hz, etc.

In some implementations and as shown in FIG. 3A, the input into the ML engine manager 260 also includes previous ML engine data 346. Previous ML engine data 346 represents output from the decoder 354 at a previous time instance, e.g., the time instance immediately before the current time.

FIG. 3B is a diagram illustrating an example data flow between input depth data 242 and output ML engine data 262. As shown in FIG. 3B, the depth data 242 is input into the ML engine manager 260. As shown in FIG. 3B, in this case the ML engine manager 260 includes an encoder 312 and a decoder 314. The encoder 312 is configured to take as input the depth data 242—specifically either the time-of-flight data 243 or ML depth data 244—and output encoded data for input into the decoder 314. The decoder 314 is configured to take as input the encoded output of the encoder 312 and output the ML engine data 262, e.g., a 6DoF pose of the mobile device in the virtual environment.

FIG. 3C is a diagram illustrating an example data flow between UWB data 248 and IMU data 252, and ML engine data 262. As shown in FIG. 3C, the UWB data 248 and the IMU data 252 are input into the ML engine manager 260. As shown in FIG. 3C, in this case the ML engine manager 260 includes an encoder 322 and a decoder 324. The encoder 322 is configured to take as input a combination of the UWB data 248 and the IMU data 252 and output encoded data for input into the decoder 324. The decoder 324 is configured to take as input the encoded output of the encoder 322 and output the ML engine data 262, e.g., a 6DoF pose of the mobile device in the virtual environment.

FIG. 3D is a diagram illustrating example rates of data acquisition of depth image data, IMU sample data, and UWB sample data compared with the rate of input into the ML engine (e.g., the refresh rate of the virtual environment). For example, the refresh rate of the virtual environment—and hence the rate of input into the ML engine—may be 120 Hz, the frame rate of the depth image data may be 30 Hz, the rate of acquisition of the UWB samples may be 10 Hz, and the rate of acquisition of the IMU samples may be 100 Hz. Accordingly, the sample windows for the ML engine input 430 include the most recent depth data 440, UWB samples 450, and IMU samples 460. At the example rates listed above, the most recent depth data 440, UWB samples 450, and IMU samples 460 are input into the ML engine at the ML engine input rate (e.g., the virtual environment refresh rate). In many cases, the input into two consecutive ML engine windows may be identical depth images and UWB and IMU samples. In some implementations, the ML engine sampling windows 430 may be wider than those of at least one of the depth data 440, UWB samples 450, and/or IMU samples 460.

Returning to FIG. 2, the rendering manager 270 is configured to produce virtual environment data 272 by rendering an image of the mobile device within the virtual environment according to the ML engine data 262. In some implementations, the rendering manager takes as input text message and/or email data from the phone and outputs the text message and/or email message represented by the (respective) text message and/or email data on the image of the mobile device at the position and orientation according to the ML engine data 262, such that the appearance is that of the user reading the text message and/or email on the image of the mobile device in the virtual environment as if the user were reading the text message and/or email on the mobile device in the physical environment.

The machine learning (ML) training manager 280 is configured to perform training on the machine learning engine of the ML engine manager 260 to produce the encoder/decoder model used to output the ML engine data 262. The ML training manager 280 uses ML training data 282 to perform the training. The ML training data 282 includes ground truth values for the position and orientation of the mobile device in conjunction with combinations of the depth data 242, the UWB data 248, and the IMU data 252. In some implementations and as shown in FIG. 2, the ML training data 282 includes QR code data 284 representing a QR code visible on a screen of the mobile device, read by the HMD, and input into ML training manager 280. In such implementations, the QR code represents the ground truth position and orientation of the mobile device in a world coordinate system at an instant of time.

The components (e.g., modules, processing units 224) of HMD circuitry 140 can be configured to operate based on one or more platforms (e.g., one or more similar or different platforms) that can include one or more types of hardware, software, firmware, operating systems, runtime libraries, and/or so forth. In some implementations, the components of the HMD circuitry 140 can be configured to operate within a cluster of devices (e.g., a server farm). In such an implementation, the functionality and processing of the components of the HMD circuitry 140 can be distributed to several devices of the cluster of devices.

The components of the HMD circuitry 140 can be, or can include, any type of hardware and/or software configured to process attributes. In some implementations, one or more portions of the components shown in the components of the HMD circuitry 140 in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the HMD circuitry 140 can be, or can include, a software module configured for execution by at least one processor (not shown). In some implementations, the functionality of the components can be included in different modules and/or different components than those shown in FIG. 2, including combining functionality illustrated as two components into a single component.

Although not shown, in some implementations, the components of the HMD circuitry 140 (or portions thereof) can be configured to operate within, for example, a data center (e.g., a cloud computing environment), a computer system, one or more server/host devices HMD circuitry 140 (or portions thereof) can be configured to operate within a network. Thus, the components of the HMD circuitry 140 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, depth sensing manager 240 (and/or a portion thereof), UWB manager 246 (and/or a portion thereof), IMU manager 250 (and/or a portion thereof), ML engine manager 260 (and/or a portion thereof), rendering manager 270 (and/or a portion thereof), and ML training manager 280 (and/or a portion thereof) are examples of such instructions.

In some implementations, the memory 226 can be any type of memory such as a random-access memory, a disk drive memory, flash memory, and/or so forth. In some implementations, the memory 226 can be implemented as more than one memory component (e.g., more than one RAM component or disk drive memory) associated with the components of the HMD circuitry 140. In some implementations, the memory 226 can be a database memory. In some implementations, the memory 226 can be, or can include, a non-local memory. For example, the memory 226 can be, or can include, a memory shared by multiple devices (not shown). In some implementations, the memory 226 can be associated with a server device (not shown) within a network and configured to serve the components of the HMD circuitry 140.

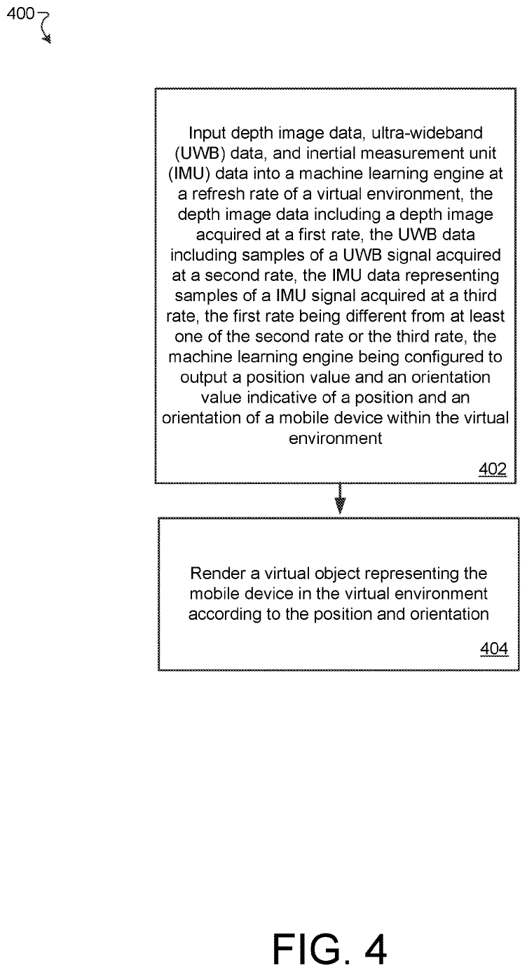

FIG. 4 is a flow chart depicting an example method 400 of outputting an image of a mobile device in a virtual environment. The method 400 may be performed by software constructs described in connection with FIG. 2, which reside in memory 226 of the HMD circuitry 140 and are run by the set of processing units 224.

At 402, a ML engine manager (e.g., ML engine manager 260) inputs depth image data, UWB data, and IMU data into a machine learning engine at a refresh rate of a virtual environment, the depth image data including a depth image acquired (e.g., with depth sensing manager 240) at a first rate, the UWB data including samples of a UWB signal acquired (e.g., with UWB manager 246) at a second rate, the IMU data representing samples of a IMU signal acquired (e.g., with IMU manager 250) at a third rate, the first rate being different from at least one of the second rate or the third rate, the machine learning engine being configured to output a position value and an orientation value indicative of a position and an orientation of a mobile device within the virtual environment.

At 404, a rendering manager (e.g., rendering manager 270) renders a virtual object representing the mobile device in the virtual environment (e.g., virtual environment data 272) according to the position and orientation.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

Accordingly, other implementations are within the scope of the following claims.

1. A method, comprising:
inputting, into a machine learning engine at a refresh rate of a virtual environment, ultra-wideband (UWB) data, and inertial measurement unit (IMU) data,
the UWB data including samples of a UWB signal acquired at a first rate,
the IMU data representing samples of a IMU signal acquired at a second rate, the first rate being different from the second rate;
the machine learning engine being configured to output a position value and an orientation value indicative of a position and an orientation of a mobile device within the virtual environment; and
rendering a virtual object representing the mobile device in the virtual environment according to the position and orientation.

2. The method as in claim 1, further comprising:
acquiring streaming content from the mobile device; and
displaying the streaming content from the mobile device at the position and orientation within the virtual environment.

3. The method as in claim 1, wherein the machine learning engine outputs a quarternion representing the orientation.

4. The method as in claim 1, further comprising:
training the machine learning engine by using previous position and orientation values from the mobile device.

5. The method as in claim 1, further comprising:
training the machine learning engine using a visual code displayed on a display device of the mobile device, the visual code representing a ground truth position and orientation of the mobile device.

6. The method as in claim 1, wherein the first rate is about 10 Hz and the second rate is about 100 Hz.

7. The method as in claim 1, wherein the refresh rate of the virtual environment is about 60 Hz.

8. A method, comprising:
inputting depth image data, ultra-wideband (UWB) data, and inertial measurement unit (IMU) data into a machine learning engine at a refresh rate of a virtual environment,
the depth image data including a depth image acquired at a first rate;
the UWB data including samples of a UWB signal acquired at a second rate;
the IMU data representing samples of a IMU signal acquired at a third rate, the first rate being different from at least one of the second rate or the third rate;
the machine learning engine being configured to output a position value and an orientation value indicative of a position and an orientation of a mobile device within the virtual environment; and
rendering a virtual object representing the mobile device in the virtual environment according to the position and orientation.

9. The method as in claim 8, further comprising:
acquiring streaming content from the mobile device; and
displaying the streaming content from the mobile device at the position and orientation within the virtual environment.

10. The method as in claim 8, wherein the machine learning engine outputs a quarternion representing the orientation.

11. The method as in claim 8, further comprising:
training the machine learning engine by using previous position and orientation values from the mobile device.

12. The method as in claim 8, further comprising:
training the machine learning engine using a visual code displayed on a display device of the mobile device, the visual code representing a ground truth position and orientation of the mobile device.

13. The method as in claim 8, wherein the first rate is about 30 Hz, the second rate is about 10 Hz, the third rate is about 100 Hz.

14. The method as in claim 8, wherein the refresh rate of the virtual environment is about 60 Hz.

15. A computer program product comprising a nontransitory storage medium, the computer program product including code that, when executed by at least one processor, causes the at least one processor to perform a method, the method comprising:
acquiring, at a first rate, depth image data in a real-world environment;
acquiring, at a second rate, a sample of an ultra-wideband (UWB) signal;
acquiring, at a third rate, a sample of an inertial measurement unit (IMU) signal, the first rate being different from at least one of the second rate or the third rate;
inputting the depth image data, the sample of the UWB signal, and the sample of the IMU signal into a machine learning engine at a refresh rate of a virtual environment, the machine learning engine being configured to output a position value and an orientation value indicative of a position and an orientation of a mobile device within the virtual environment; and
rendering a virtual object representing the mobile device in the virtual environment according to the position and orientation.

16. The computer program product as in claim 15, further comprising:
acquiring streaming content from the mobile device; and
displaying the streaming content from the mobile device at the position and orientation within the virtual environment.

17. The computer program product as in claim 15, wherein the machine learning engine outputs a quarternion representing the orientation.

18. The computer program product as in claim 1, further comprising:
training the machine learning engine by using previous position and orientation values from the mobile device.

19. The computer program product as in claim 15, further comprising:
training the machine learning engine using a visual code displayed on a display device of the mobile device, the visual code representing a ground truth position and orientation of the mobile device.

20. The computer program product as in claim 15, wherein the first rate is about 30 Hz, the second rate is about 10 Hz, the third rate is about 100 Hz.

21. The computer program product as in claim 15, wherein the refresh rate of the virtual environment is about 60 Hz.

22. An apparatus, comprising:
memory; and
processing circuitry coupled to the memory, the processing circuitry being configured to:
input depth image data, ultra-wideband (UWB) data, and inertial measurement unit (IMU) data into a machine learning engine at a refresh rate of a virtual environment,
the depth image data including a depth image acquired at a first rate;
the UWB data including samples of a UWB signal acquired at a second rate;
the IMU data representing samples of a IMU signal acquired at a third rate, the first rate being different from at least one of the second rate or the third rate;
the machine learning engine being configured to output a position value and an orientation value indicative of a position and an orientation of a mobile device within the virtual environment; and
render a virtual object representing the mobile device in the virtual environment according to the position and orientation.

23. The apparatus as in claim 22, wherein the processing circuitry is further configured to:
acquire streaming content from the mobile device; and
display the streaming content from the mobile device at the position and orientation within the virtual environment.

24. The apparatus as in claim 22, wherein the machine learning engine outputs a quarternion representing the orientation.

25. The apparatus as in claim 22, wherein the processing circuitry is further configured to:
train the machine learning engine by using previous position and orientation values from the mobile device.

26. The apparatus as in claim 22, wherein the processing circuitry is further configured to:
train the machine learning engine using a visual code displayed on a display device of the mobile device, the visual code representing a ground truth position and orientation of the mobile device.

27. The apparatus as in claim 22, wherein the first rate is about 30 Hz, the second rate is about 10 Hz, the third rate is about 100 Hz.

28. The apparatus as in claim 22, wherein the refresh rate of the virtual environment is about 60 Hz.
